(19) United States
(12) Patent Application Publication
(10) Pub. No.: US 2010/0332681 A1
(43) Pub. Date: Dec. 30, 2010

(54) COMMUNICATION APPARATUS CAPABLE OF SELECTING A PROPER SOURCE ADDRESS FROM A PLURALITY OF SOURCE ADDRESSES ASSIGNED THERETO, METHOD OF CONTROLLING THE SAME, AND STORAGE MEDIUM

(75) Inventor: Katsuhiro WADA, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/826,045

(22) Filed: Jun. 29, 2010

(30) Foreign Application Priority Data
Jun. 29, 2009 (JP) 2009-153931

(51) Int. Cl. G06F 15/16

(52) U.S. Cl. 709/245

(57) ABSTRACT

A communication apparatus capable of selecting a proper source address even when a plurality of source addresses are assigned thereto and reducing the occurrence of a communication error caused by a source address change during communication processing. A transmission section transmits data. A transmission information management section manages transmission information including data identification information for identifying a type of data to be transmitted, and a destination address and source address of the data. A source address-determining section is operable when data to be transmitted is of a specific type, to refer to the managed transmission information, and out of the assigned source addresses, determine a source address used in the past for transmitting data to a destination address of the data to be transmitted, as a source address thereof. A communication control section causes the transmission section to transmits the data using the determined source address.

### BACKGROUND OF THE INVENTION

1. Field of the Invention

The present invention relates to a communication apparatus that is assigned a plurality of source addresses used for network communication, a method of controlling the communication apparatus, and a storage medium.

2. Description of the Related Art

Conventionally, various kinds of apparatuses including PCs (personal computers), printers, and MFPs (Multi-Function Peripherals) have been used as communication apparatuses that can be connected to networks, such as an intranet, the Internet, a LAN and the like. In general, a protocol widely used among communication apparatuses connected to networks is Internet Protocol (IP). Under the IP, a unique IP address is assigned to each apparatus, whereby connected apparatuses identify each other on an IP address basis.

In general, under the conventional IP protocols (IPv4 (IP version 4)), a single IP address is assigned to a single network interface (I/F) as an IP address for identifying one communication apparatus from others on a network. On the other hand, under IPv6 (IP version 6), which is recently coming into widespread use, a communication apparatus communicates with a router upon connection to the same to automatically acquire an IP address. Further, aside from the thus acquired IP addresses, to enable communication even when no router exists, an IPv6 address is assigned on a network I/F basis. Further, in a case where a DHCP server exists, the communication apparatus acquires an IP address issued by the DHCP server.

As mentioned above, it is a general practice to assign a plurality of IPv6 addresses to a single network I/F. As a consequence, in a communication apparatus supporting IPv6, a single network I/F is assigned an IPv4 address and a plurality of IPv6 addresses. In the communication apparatus that is assigned a plurality of IP addresses, there has been proposed a method of selecting an IP address for properly performing communication (see Internet Engineering Task Force RFC 3484 “Default Address Selection for Internet Protocol version 6 (IPv6)”<URL: http://www.ietf.org/rfc/RFC3484.txt>).

By the way, in some of network systems each formed by a plurality of communication apparatuses, a server provides services according to a source address of each of its clients. For example, this kind of server includes a Web server which changes provided information according to the source address of a client, and a communication server which performs authentication on a client address basis. Such a system on a client address basis is generally widely applied to communication systems irrespective of the types of communication protocols and applications (see Japanese Patent Laid-Open Publication No. 2001-282728).

In the conventional system in which a server provides services according to the source address each of its clients, the client sometimes performs communication using a plurality of source addresses during a sequence of communication processes. In this case, in a communication server which changes provided information according to the source address of each client or a communication server which performs authentication based on a client address, if the source address is changed during processing of a sequence of transactions, a communication error is sometimes caused.

When a source address is selected according to the source address selection defined in RFC 3484 as well, the network environment is dynamically changed. Therefore, a same source address is not always selected in association with a same destination address.

### SUMMARY OF THE INVENTION

The present invention provides a communication apparatus that is capable of selecting a proper source address even when a plurality of source addresses are assigned thereto, and reducing the occurrence of a communication error caused by a source address change during communication processing, a method of controlling the communication apparatus, and a storage medium which stores a program for executing the control method.

In a first aspect of the present invention, there is provided a communication apparatus that is assigned a plurality of source addresses for use in network communication, comprising a transmission unit adapted to transmit data, a management unit adapted to manage transmission information including data identification information for identifying a type of data to be transmitted by the transmission unit, a destination address of the data to be transmitted, and a source address of the data to be transmitted, a determining unit adapted to be operable when data to be transmitted by the transmission unit is of a specific type, to refer to the transmission information managed by the management unit, and out of the plurality of source addresses assigned to the communication apparatus, determine a source address that was used in the past for transmitting data to a destination address of the data to be transmitted, as a source address of the data, and a control unit adapted to control the transmission unit such that the transmission unit transmits the data using the source address determined by the determining unit.

In a second aspect of the present invention, there is provided a method of controlling a communication apparatus that is assigned a plurality of source addresses for use in network communication, comprising transmitting data, managing transmission information including data identification information for identifying a type of data to be transmitted, a destination address of the data to be transmitted, and a source address of the data to be transmitted, referring to, when data to be transmitted by the transmitting is of a specific type, the managed transmission information, and out of the plurality of source addresses assigned to the communication apparatus, determining a source address that was used in the past for transmitting data to a destination address of the data to be transmitted, as a source address of the data, and controlling the transmitting such that the transmitting transmits the data using the determined source address.

In a third aspect of the present invention, there is provided a non-transitory computer-readable storage medium storing a computer-executable program for causing a communication apparatus that is assigned a plurality of source addresses for use in network communication, wherein the method comprises transmitting data, managing transmission information including data identification information for identifying a type of data to be transmitted, a destination address of the data to be transmitted, and a source address of the data to be transmitted, referring to, when data to be transmitted by the transmitting is of a specific type, the managed transmission information, and out of the plurality of source addresses assigned to the communication apparatus, determining a source address that was used in the past for transmitting data to a destination address of the data to be transmitted, as a source address of the data, and controlling the transmitting such that the transmitting transmits the data using the determined source address.

According to the present invention, even when a plurality of source addresses are assigned, it is possible to select a proper source address during communication processing, and reduce occurrence of a communication error caused by address selection.

Further features of the present invention will become apparent from the following description of exemplary embodiments with reference to the attached drawings.

### BRIEF DESCRIPTION OF THE DRAWINGS

FIG. 1 is a network configuration diagram of an example of a network environment in which a client PC as a communication apparatus according to a first embodiment of the present invention is set up.

FIG. 2 is a schematic block diagram of the client PC appearing in FIG. 1.

FIG. 3 is a schematic functional block diagram of the client PC and a server PC.

FIG. 4 is a view showing an example of a transmission information management table stored in a transmission information-storing section appearing in FIG. 3.

FIG. 5 is a view showing an example of transmission data identification information stored in a transmission data identification information-storing section appearing in FIG. 3.

FIGS. 6A and 6B are a flowchart of a communication process executed by a client communication control section of the client PC.

FIGS. 7A and 7B are a flowchart of a communication process executed by a client communication control section of a client PC according to a second embodiment of the present invention.

### DETAILED DESCRIPTION OF THE EMBODIMENTS

The present invention will now be described in detail below with reference to the accompanying drawings showing embodiments thereof.

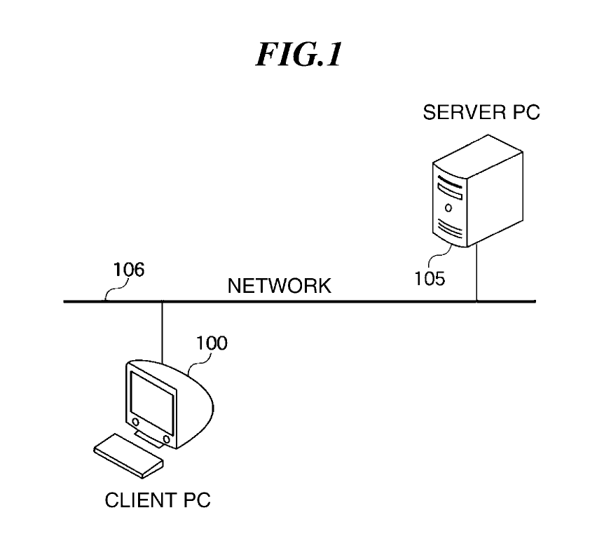

FIG. 1 is a network configuration diagram of an example of a network environment in which a client PC as a communication apparatus according to a first embodiment of the present invention is set up.

As shown in FIG. 1, a client PC 100 as an example of the communication apparatus according to the first embodiment of the present invention is connected to a server PC 105 via a network 106 implemented by e.g. a LAN (Local Area Network) or a WAN (Wide Area Network).

The client PC 100 holds an IP address so as to communicate with the server PC 105 or other communication apparatuses, not shown, via the network 106. The server PC 105 provides services in response to requests from the client PC 100. The services provided by the server PC 105 include Web, DNS, mail, SNMP agent, WS-Eventing, and like services. It should be noted that types of protocols used in the services provided by the server PC 105 are not limited insofar as the services use IP addresses for communication.

If the client PC 100 holds a plurality of IP addresses, it is required to select a proper one suited to an address (destination address) of the server PC 105 from those addresses.

Although in the illustrated example, the network environment includes the client PC 100, the server PC 105, and the network 106, there may be also connected thereto any of network devices, information processing apparatuses, and communication apparatuses other than these. Further, as for the method of communication between the client PC 100 and the server PC 105, it is to be understood that there may be employed a network other than the LAN and the WAN, or a wireless LAN defined by the IEEE802.11, or an IEEE 1394 interface.

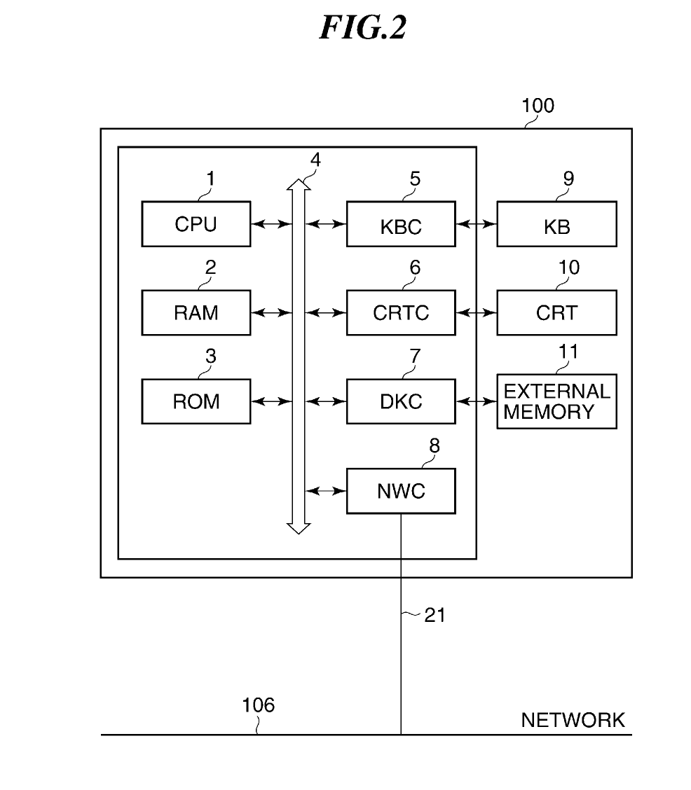

FIG. 2 is a schematic block diagram of the client PC 100 appearing in FIG. 1.

A CPU 1 is a central processing unit that performs centralized control of components connected to a system bus 4. A RAM 2 is a memory that functions as a main memory, a work area, and the like of the CPU 1. A ROM 3 is a memory comprising a font ROM (not shown), a program ROM (not shown), and a data ROM (not shown). An external memory 11 is implemented by a hard disk (HD), a floppy (registered trademark) disk (FD), etc. The external memory 11 stores a boot program, various applications, font data, user files, edited files, etc.

The font ROM or the external memory 11 stores font data and the like for use in document processing, referred to hereinafter. The program ROM or the external memory 11 stores an operating system (hereinafter referred to as the “OS”) as a control program of the CPU 1, etc. The data ROM or the external memory 11 stores various kinds of data for use in document processing, referred to hereinafter. The programs stored in the external memory 11 are each loaded in the RAM 2 when executed.

The CPU 1 executes various processes including document processing for processing a document containing graphics, images, text, and tables (including spreadsheets) in a mixed manner based on applications (a document processing program, and so forth) stored in the program ROM in the ROM 3 or the external memory 11. Further, the CPU 1 carries out processing for rasterizing an outline font e.g. into a display RAM secured in the RAM 2, to thereby display character strings on a CRT 10 via a CRT controller (CRTC) 6.

A keyboard controller (KBC) 5 controls information input from a keyboard (KB) 9 provided with various keys or by a pointing device (not shown). The CRTC (CRT controller) 6 controls display on the CRT 10. Although the CRT 10 is a display device for displaying graphics, images, text, tables, etc., and is implemented by a CRT, the CRT 10 may be implemented by a liquid crystal display device, a plasma display device, or the like. A disc controller (DKC) 7 controls access to the external memory 11. A network controller (NWC) 8 is connected to the network 106 via a bidirectional interface 21.

Based on a command designated by a mouse cursor (not shown) or the like on the CRT 10, the CPU 1 opens an associated one of various windows and executes an associated one of various data processes. In the case of using a client application 101 or a server application 108, referred to hereinafter, a user can open a configuration window for the application to configure various settings on the window.

It should be noted that the server PC 105 appearing in FIG. 1 has the same configuration as that of the client PC 100 illustrated in FIG. 2, and hence a description thereof is omitted.

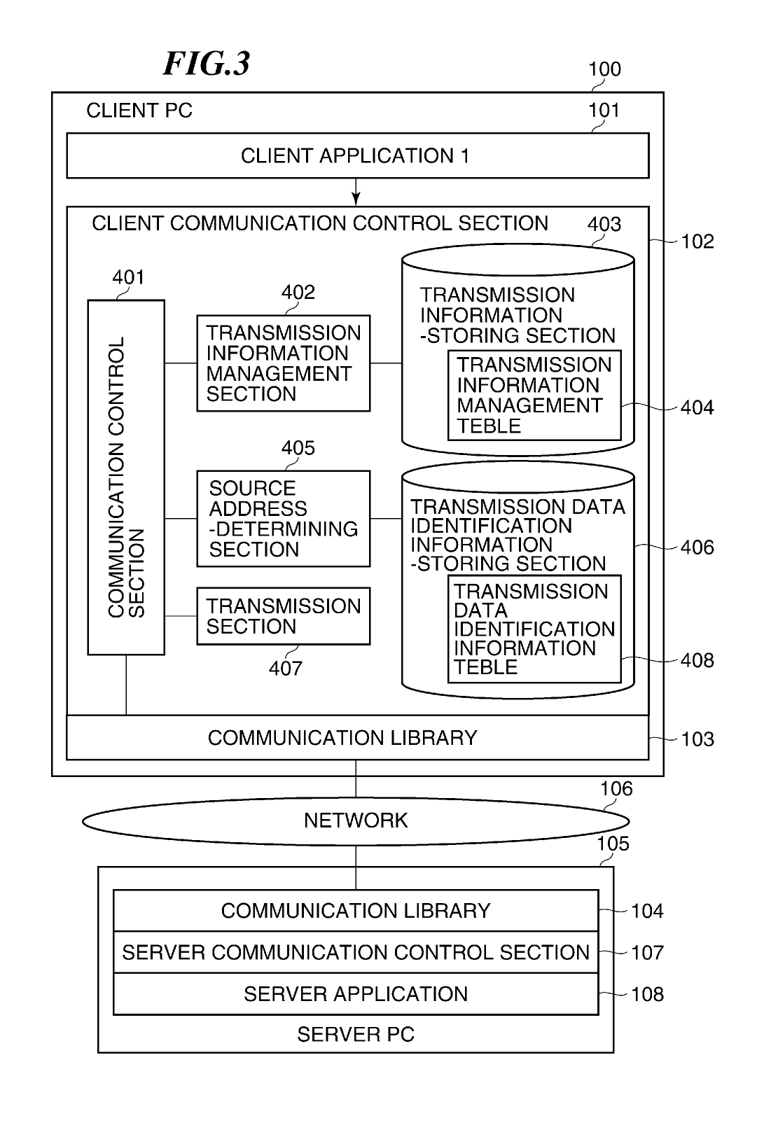

FIG. 3 is a schematic functional block diagram of the client PC 100 and the server PC 105.

In response to a request from the client application 101, the client PC 100 performs communication with the server PC 105 via a client communication control section 102 and a communication library 103. Although in the illustrated example, only client application 101 operates on the client PC, a plurality of client applications may operate thereon.

The client application 101 communicates with the client communication control section 102. The client communication control section 102 communicates with the server PC 105 via the communication library 103 of the OS. Although the communication library 103 is assumed to perform socket communication, the communication library 103 is also capable of performing communication by RPC (Remote Procedure Call), LPC (Local Procedure Call), Web service, or the like.

The server application 108 operates on the server PC 105. The server application 108 communicates with a server communication control section 107. The server communication control section 107 communicates with the client PC 100 via the network 106 through a communication library 104.

The client communication control section 102 comprises a communication control section 401, a transmission information management section 402, a transmission information-storing section 403, a transmission information management table 404, a source address-determining section 405, a transmission data identification information-storing section 406, and a transmission section 407.

The communication control section 401 performs acquisition of transmission information and determination of the source address using the sections comprising the client communication control section 102, and sets the source address used for communication according to the result of determination. Then, communication control between the client PC 100 and the server PC 105 is carried out.

The transmission information management section 402 acquires and manages addresses used for transmission data and communication. Information acquired by the transmission information management section 402 includes e.g. application identification for identifying the client application which uses the client communication control section 102. Further, the information includes transmission data identification information for identifying a type of transmission data. Further, the information includes an IP address and a port number as a destination address of transmission data. Furthermore, the information includes an IP address and a port number as a source address of transmission data.

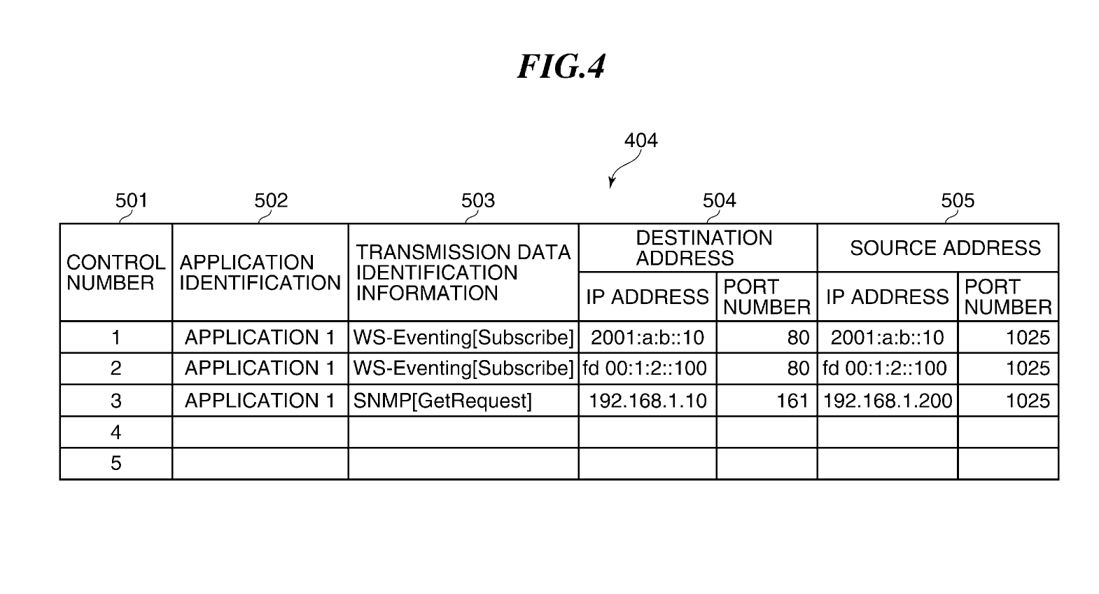

The transmission information-storing section 403 stores the transmission data information and the address information acquired by the transmission information management section 402 as the transmission information management table 404. FIG. 4 shows an example of the transmission information management table 404. It should be noted that the transmission information-storing section 403 is a storage area secured in the external memory 11 or the like in actuality, and the transmission information management table 404 is assumed to be stored therein.

The source address-determining section 405 determines a source address to be used for the network communication. If there is no applicable transmission information in the transmission information management table 404 stored in the transmission information-storing section 403, the determination of the source address is carried out according to the source address selection defined in RFC 3484. On the other hand, if there is applicable transmission information in the transmission information management table 404 stored in the transmission information-storing section 403, the source address-determining section 405 determines a source address used for data transmission performed in the past as the source address to be used for the current communication.

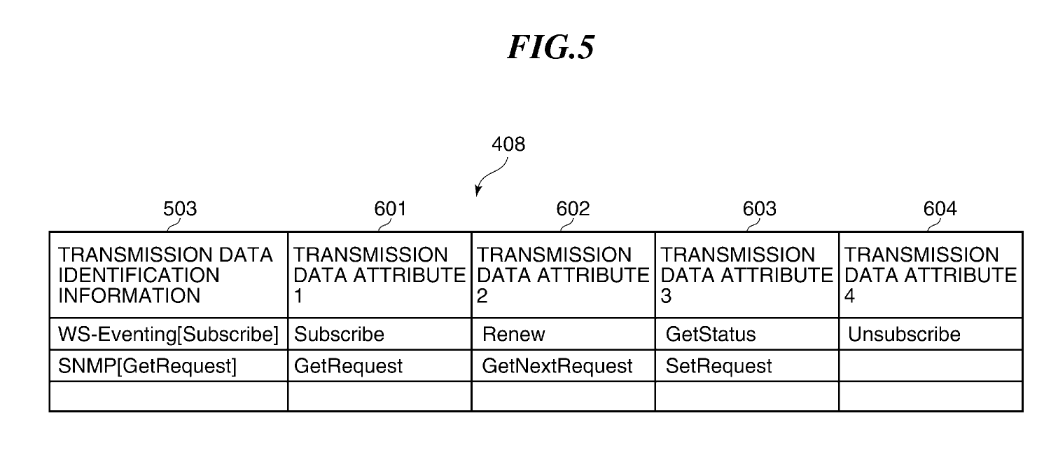

The transmission data identification information-storing section 406 stores a transmission data identification information table 408 for determining transmission data required to be transmitted using a same source address. FIG. 5 shows an example of the transmission data identification information table 408 stored in the transmission data identification information-storing section 406.

The transmission section 407 transmits transmission data to a destination address according to an instruction from the client application 101. At this time, the transmission section 407 performs data transmission using the source address determined by the source address-determining section 405. The transmission section 407 may use a non-connection-type protocol in transmitting the transmission data. Further, the non-connection-type protocol may be a UDP protocol.

FIG. 4 is a view showing an example of the transmission information management table 404 stored in the transmission information-storing section 403 appearing in FIG. 3.

In FIG. 4, the transmission information management table 404 is a management table managed by the transmission information management section 402. The transmission information management table 404 comprises control numbers 501, application identification information items 502, transmission data identification information items 503, destination addresses 504, and source addresses 505.

Each control number 501 is a number given by the transmission information management section 402 when a transmission data information item and an address information item are stored in the transmission information-storing section 403. Each application identification information item 502 is identification information for identifying a client application which uses the client communication control section 102. Each transmission data identification information item 503 is identification information for identifying a transmission data item. Each destination address 504 is an address of a destination to which a transmission data item is sent, and is formed by a combination of an IP address and a port number. Each source address 505 is an address of a source from which a transmission data item is sent, and is formed by a combination of an IP address and a port number.

In the illustrated example, “Application 1” as an application identification information item 502 is associated with “WS-Eventing [Subscribe]” as a transmission data identification information item 503. Further, a combination of an IP address [2001:a:b::10] and a port number [80] and a combination of an IP address [fd00:1:2::100] and a port number [80] as destination addresses 504 are each associated with the combination of “Application 1” and “WS-Eventing [Subscribe]”.

On the other hand, “Application 1” as the application identification information item 502 is associated with “SNMP [GetRequest]” as a transmission data identification information item 503. Further, a combination of an IP address [192.168.1.10] and a port number [161] as a destination address 504 is associated with the combination of “Application 1” and “SNMP [GetRequest]”.

Here, “Application 1” is, for example, identification information assigned to the client application 101. It is assumed that the other client applications are assigned e.g. “Application 2”, “Application 3”, . . . , and so forth. The form of the identification information is not limited to this.

Therefore, when the client application 101 represented by “Application 1” transmits transmission data which is required to be transmitted from a same source address and is associated with “WS-Eventing [Subscribe]” to a predetermined destination address, the source address is set as follows: If the predetermined destination address is formed by the combination of the IP address [2001:a:b::10] and the port number [80], the IP address [2001:a:b::200] and the port number [1025] are set as a source address 505, and communication is performed using this source address 505.

However, when the client application 101 represented by “Application 1” transmits transmission data which is required to be transmitted from the same source address and is associated with “WS-Eventing [Subscribe]” to a destination address which is not found in the destination addresses 504 in the transmission information management table 404, the source address is set as follows: If a combination of an IP address [2001::1000] and a port number [80], for example, are not found in the destination addresses 504, a source address is set according to the source address selection defined in RFC 3484, and communication (normal transmission) is performed. Then, the transmission information including the source address is stored in the transmission information management table 404 in the transmission information-storing section 403.

Further, also in a case where “Application 1” transmits transmission data which is not required to be transmitted from a same source address (data which is not registered as one of the transmission data identification information items 503), a source address is set in the same manner as described above. That is, the source address is set according to the source address selection defined in RFC 3484, and communication (normal transmission) is performed using the source address. In this case, since it is not required to transmit the data from a same source address, the transmission information including the source address is not stored in the transmission information management table 404 in the transmission information-storing section 403.

FIG. 5 is a view showing an example of the transmission data identification information table 408 stored in the transmission data identification information-storing section 406 appearing in FIG. 3.

In FIG. 5, the transmission data identification information table 408 is a management table which is stored in the transmission data identification information-storing section 406, and is formed by grouping transmission data identification information items each for identifying a transmission data item required to be transmitted from a same source address and an attribute information item associated with the transmission data identification information item. The transmission data identification information table 408 comprises transmission data identification information items 503 appearing in FIG. 4, a transmission data attribute 1 601, a transmission data attribute 2 602, a transmission data attribute 3 603, and a transmission data attribute 4 604, which are associated with the transmission data identification information items 503, respectively. It should be noted that although in the illustrated example, four types of transmission data attributes 1 to 4 are set, the types of transmission data attributes are not limited to these.

In a group indicated by a transmission data identification information item 503 of “WS-Eventing [Subscribe]”, the following are registered in association therewith as attribute values of transmission data: “Subscribe” as a transmission data attribute 1 601, “Renew” as a transmission data attribute 2 602, “GetStatus” as a transmission data attribute 3 603, and “Unsubscribe” as a transmission data attribute 4 604.

If a transmission data item contains a “Subscribe” message, a “Renew” message, a “GetStatus” message, or a “Unsubscribe” massage of WS-Eventing, this means that the transmission data item is to be subjected to transmission processing as “transmission data required to be transmitted from a same source address”. The “transmission data required to be transmitted from a same source address” may be registered in the transmission data identification information table 408 in association with commands based on other protocols (SNMP, SMTP, HTTP, etc.)

Further, the protocols are not limited to ones for a specific layer of the OSI (Open Systems Interconnection) reference model, but insofar as the transmission data item is data which can be interpreted by the communication apparatus, the protocols over a plurality of layers may be registered in the transmission data identification information table 408.

A method of registering transmission data required to be transmitted from a same source address includes, for example, a method in which the client application 101 registers a transmission data item in the transmission data identification information-storing section 406 via the client communication control section 102. Further, there is also a method in which a transmission data item is registered from the server application 108 or the server communication control section 107 of the server PC 105 via the client communication control section 102, but the registration method is by no means limited to the above-mentioned ones.

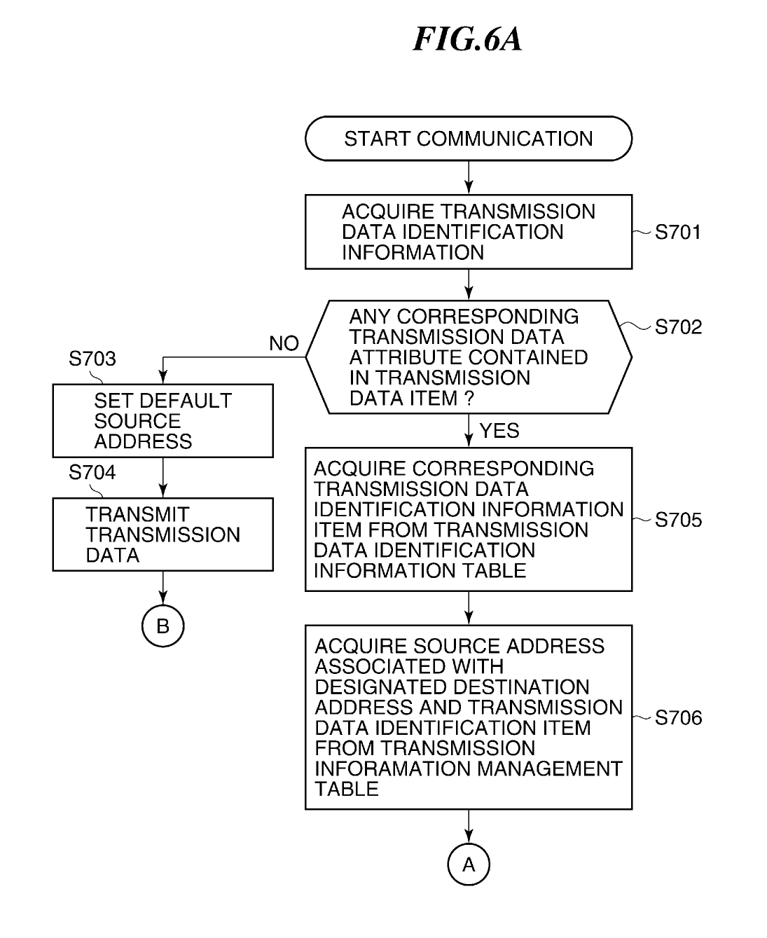

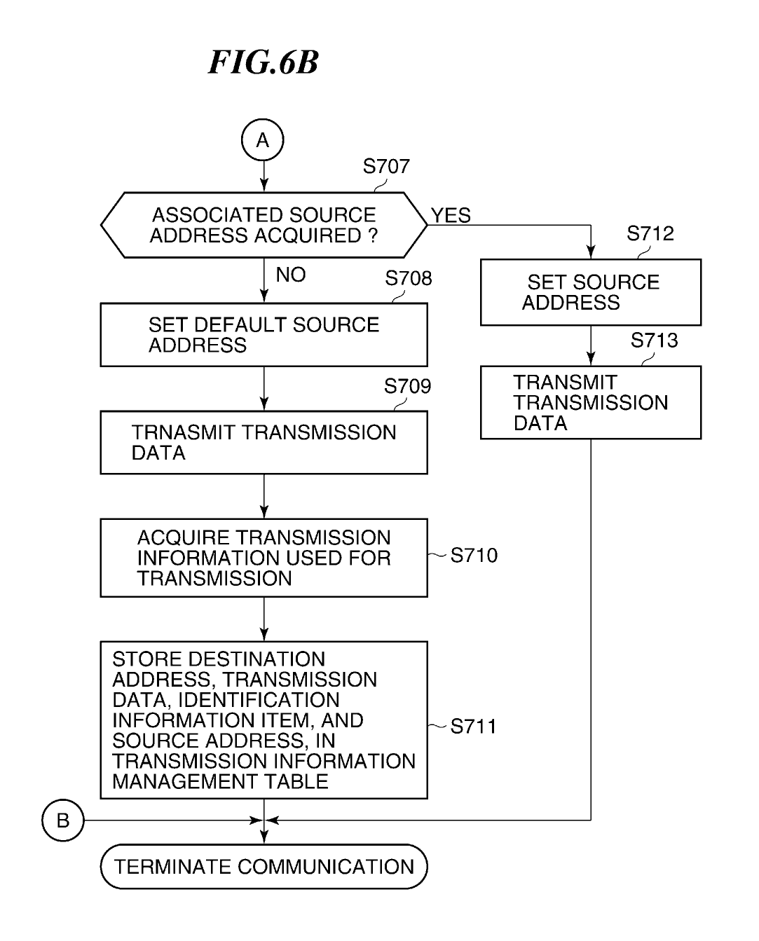

FIGS. 6A and 6B are a flowchart of a communication process executed by the client communication control section 102 of the client PC 100. The present process is an example of a process for transmitting data to the server PC 105, which is executed in response to an instruction for transmitting data from the client application 101 (application 1).

In a step S701, the source address-determining section 405 acquires the transmission data identification information table 408 from the transmission data identification information-storing section 406 in order to determine a transmission data item required to be transmitted from a same source address. This makes it possible to acquire, from the transmission data identification information table 408 shown in FIG. 5, for example, the attribute values of the transmission data identification information item 503 “WS-Eventing [Subscribe]”, as information enabling determination of a transmission data item required to be transmitted from a same source address. The attribute values of “WS-Eventing [Subscribe]” are the transmission data attribute 1 601 of “Subscribe”, the transmission data attribute 2 602 of “Renew”, the transmission data attribute 3 603 of “GetStatus”, and the transmission data attribute 4 604 of “Unsubscribe”. Further, as the attribute values of “SNMP [GetRequest]” as another transmission data identification information item 503, it is possible to acquire a transmission data attribute 1 601 of “GetRequest”, a transmission data attribute 2 602 of “GetNextRequest”, and a transmission data attribute 3 603 of “SetRequest”.

Next, in a step S702, the transmission information management section 402 refers to the transmission data identification information items acquired in the step S701, and determines whether or not any of the transmission data attributes corresponds to one contained in the transmission data item which the client application 101 has instructed to be transmitted. The step S702 corresponds to the function of an attribute-determining unit in the present invention.

If it is determined in the step S702 that none of the acquired transmission data attributes are contained in the transmission data item, the source address-determining section 405 executes processing in a step S703. That is, the source address-determining section 405 sets a default source address according to the source address selection defined in RFC 3484 based on the destination address designated by the client application 101 (step S703).

Next, in a step S704, the transmission section 407 transmits the transmission data item using the source address set in the step S703 to the server PC 105, followed by terminating the communication.

On the other hand, if it is determined in the step S702 that the transmission data item contains any of the acquired transmission data attributes, the process proceeds to a step S705. In the step S705, the transmission information management section 402 acquires the transmission data identification information item 503 associated with the transmission data attribute 1 601 contained in the transmission data item, from the transmission data identification information table 408. For example, if the transmission data item is a Subscribe message of WS-Eventing, [Subscribe] as the transmission data attribute 1 601 is an associated attribute, and hence the transmission information management section 402 acquires WS-Eventing [Subscribe] as the transmission data identification information item 503.

Next, in a step S706, the source address-determining section 405 refers to the transmission information management table 404 stored in the transmission information-storing section 403, and acquires a source address associated with the transmission data identification information item 503 acquired in the step S705 based on the destination address designated by the client application 101.

Next, in a step S707, the source address-determining section 405 determines whether or not it is possible to acquire an associated source address from the transmission information management table 404. As a result, if there is no associated source address in the transmission information management table 404, and hence the source address-determining section 405 cannot acquire the source address, the source address-determining section 405 executes processing in a step S708. That is, as communication to a new destination, the source address-determining section 405 sets a default source address according to the source address selection defined in RFC 3484 based on the destination address designated by the client application 101 (step S708).

In a step S709, the transmission section 407 transmits the transmission data item using the source address set in the step S708 to the server PC 105. Then, in a step S710, the transmission information management section 402 acquires transmission information on the transmission data item transmitted by the transmission section 407 in the step S709.

In a step S711, the transmission information management section 402 stores the transmission information acquired in the step S710 in the transmission information management table 404 stored in the transmission information-storing section 403, followed by terminating the communication. The transmission information stored in the transmission information management table 404 in the step S711 contains the transmission data identification information item 503 acquired in the step S705, the destination address designated by the client application 101, and the source address set in the step S708.

For example, when transmitting data associated with the transmission data identification information item “WS-Eventing [Subscribe]” to the IP address [2001::1000] and the port number [80] of the destination address, the following new set of records is registered in the transmission information management table 404: “Application 1”, “WS-Eventing [Subscribe]”, the IP address [2001::1000] and the port number [80] of the destination address, and the source address used for transmission in the step S709. Here, “data associated with the transmission data identification information “WS-Eventing [Subscribe]” “is intended to mean data which contains [Subscribe], [Renew], [GetStatus], and [Unsubscribe] of WS-Eventing, for example.

If the source address-determining section 405 acquires the associated source address from the transmission information management table 404 in the step S707, the source address-determining section 405 sets the address acquired in the step S706 to the source address (step S712). When transmitting data associated with the transmission data identification information “WS-Eventing [Subscribe]” to the IP address [2001:a:b::10] and the port number [80] of the destination address, the communication is performed using the IP address [2001:a:b::200] and the port number [1025] of the same source address.

In a step S713, the transmission section 407 transmits the transmission data using the source address set in the step S712 to the server PC 105, followed by terminating the communication.

If it is determined in the step S707 that the transmission information management table 404 does not contain any source address associated with the acquired transmission data identification information and the destination address, the transmission information management section 402 may store only the source address set in the step S708, in the vacant fields of the source address 505 associated with the associated combination of the acquired transmission data identification information and the destination address in the transmission information management table 404, in the step S711.

According to the above-described first embodiment, in the communication system in which the server PC provides services according to the source address of a client PC, even if the client PC holds a plurality of source addresses, it is possible to select a proper source address. Further, it is possible to reduce occurrence of a communication error due to a change in the source address during communication processing, and thereby make effective use of network resources or PC resources.

In the present embodiment, as an example of the method of determining the source address, it is employed to determine the source address according to the source address selection defined in RFC 3484 when there is no applicable transmission information item in the transmission information management table 404 stored in the transmission information-storing section 403. However, the method of determining the source address is not limited to this.

Next, a second embodiment of the present invention will be described. A communication apparatus according to the second embodiment of the present invention has the same configuration as that of the communication apparatus according to the first embodiment, described hereinabove with reference to FIGS. 1 to 3, and hence component elements identical to those in the first embodiment are denoted by the same reference numerals, while omitting the description thereof. Hereafter, only different points from the first embodiment will be described.

In the above-described first embodiment, when the transmission section 407 transmits a transmission data item having transmission data attributes registered in the transmission data identification information-storing section 406 to a destination address having a different IP address and port number, for the first time, according to an instruction by the client application 101, a source address used in this transmission is registered in the transmission information management table in association with the aforementioned other information items.

However, it is conceivable that there is a case where the source address used in the first transmission becomes invalid due to a change of the address of the communication apparatus or the like. When communication failure is caused in a state where there is a registered source address, if the registered source address continues to be used, communication becomes impossible even when communication using other source addresses is possible.

To prevent this problem, a description will be given of the communication apparatus according to the present embodiment, which is capable of performing communication even when such a communication error occurs, if there is a source address that enables communication.

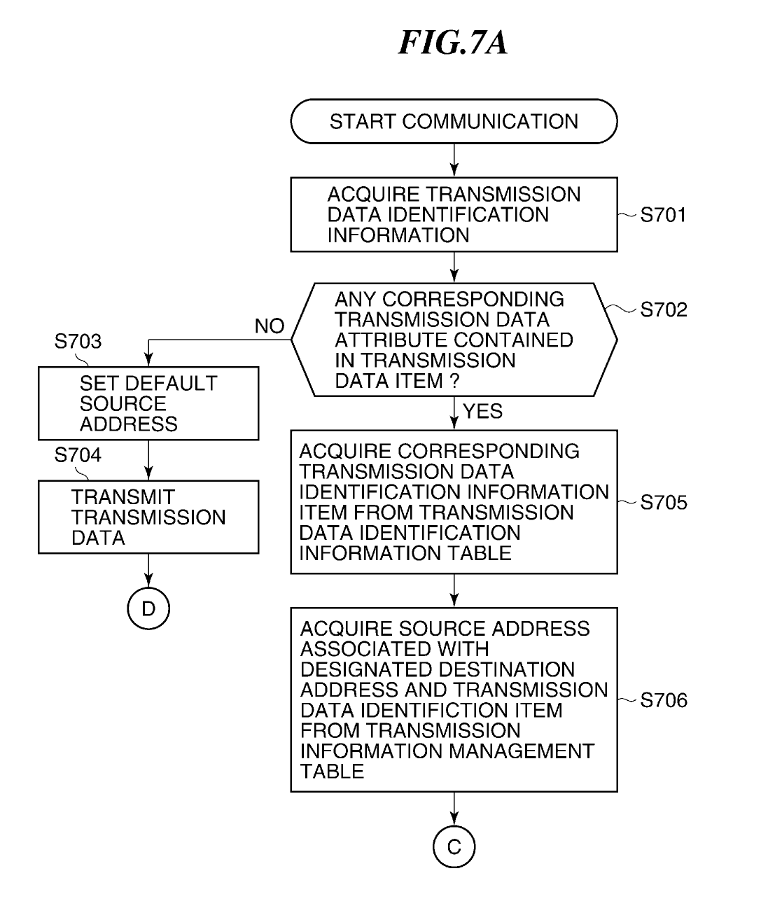

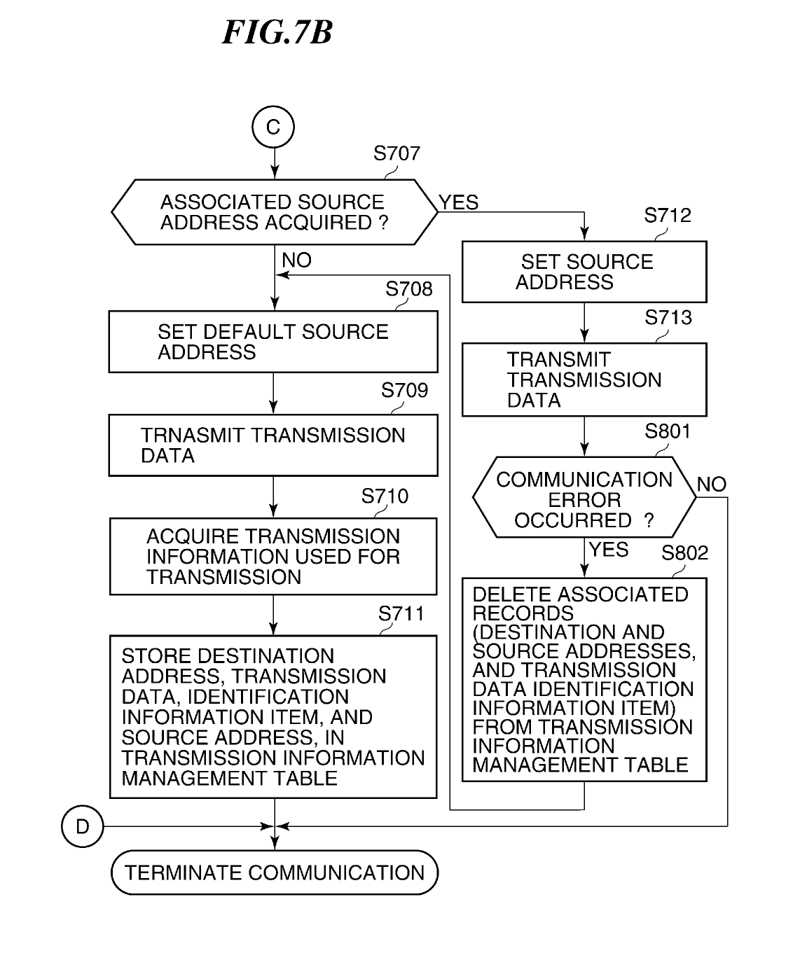

FIGS. 7A and 7B are a flowchart showing a communication process executed by the client communication control section 102 of the client PC 100 which is the communication apparatus according to the second embodiment of the present invention. It should be noted that steps S701 to S713 in FIGS. 7A and 7B are the same as those in FIGS. 6A and 6B, and hence are denoted by the same step numbers, while omitting the description thereof.

Referring to FIG. 7B, in the step S713, the transmission section 407 transmits the transmission data using the source address set in the step S712 to the server PC 105. At this time, the transmission section 407 acquires a result of the transmission from the communication library 103 of the OS.

Next, in a step S801, the transmission section 407 determines based on the transmission result acquired in the step S713 whether or not a communication error has occurred. The step S801 corresponds to the function of a communication error-determining unit in the present invention. As a result of the determination in the step S801, if it is determined that no communication error has occurred, the transmission section 407 terminates the communication.

On the other hand, if it is determined that any communication error has occurred, the transmission section 407 deletes the associated records (transmission data identification information item 503, destination address 504, and source address 505) from the transmission information management table 404 (step S802). Then, the process proceeds to the step S708.

According to the above-mentioned processing, when the client application 101 retransmits or newly transmits a transmission data item to a same destination address associated with a same transmission data identification information item, if there is at least one source address which enables communication, it is possible to continue communication even when a communication failure occurs.

Further, if a source address associated with a same transmission data identification information and destination address is changed due to e.g. a communication failure or a change of the address of the client PC 100, the following processing may be performed: The communication control section 401 may notify the client application 101 that the source address has changed during a communication session, thereby notifying a user or the communication system of the change of the source address.

In the above-described embodiment, the description has been given of the configuration that according to the determination of occurrence of a communication error in the step S801, the corresponding information items used for setting up a communication session are deleted from the transmission information management table 404. However, in addition to the determination of occurrence of a communication error, when the client communication control section 102, which receives a request for starting or terminating a communication session from the client application 101, receives the terminating request, the corresponding information items used for setting up the communication session may be deleted from the transmission information management table 404. Further, when a predetermined time period elapses after termination of a communication session set up using information items in the transmission information management table 404 and during which a data item is transmitted by the transmission section 407, the corresponding information items may be deleted from the transmission information management table 404. Furthermore, when the number of times of unsuccessful communication attempts by the transmission section 407 exceeds a predetermined number, information items used for setting up the communication session may be deleted. The deletion of the corresponding information items, mentioned above, is intended to mean deletion of the corresponding records (the transmission data identification information item 503, the destination address 504, and the source address 505) from the transmission information management table 404.

According to the above-described second embodiment, it is possible to obtain the same advantageous effects as provided by the first embodiment. Further, according to occurrence of a communication error in data transmission to the set source address, the corresponding records are deleted from the transmission information management table 404. Therefore, it is possible to reduce network resources wastefully used due to occurrence of a communication error, and provide a highly reliable and efficient communication apparatus.

Although the selection of a source address, described in the first and second embodiments, may be performed by a method of configuring a policy table defined in RFC 3484 for a client, or a method of configuring a routing table, method is not limited to a specific method.

Further, in the above-described first and second embodiments, the description has been given of an example of selecting a source address which is an

IP address in the third layer, i.e. the network layer of the OSI reference model. The present invention can be also similarly applied in selecting a source address, in a case where the source address information is contained in a layer higher than the third layer of the OSI reference model.

Further, although in the above-described first and second embodiments, the description has been given of the case in which the present invention is applied to a single apparatus, the present invention may be applied to a system comprising a plurality of devices and apparatuses. Further, it is to be understood that insofar as the above-described functions of the present invention are realized, the operations of programs on the client PC 100 and the server PC 105 may be executed using a CPU, a RAM, and a ROM provided in a printer or an MFP (Multi-Function Peripheral).

It is to be understood that the present embodiments of the present invention may also be accomplished by causing a personal computer (CPU, processor) to execute software (program) acquired via a network or various kinds of storage medium.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-153931, filed Jun. 29, 2009, which is hereby incorporated by reference herein in its entirety.

What is claimed is:

1. A communication apparatus that is assigned a plurality of source addresses for use in network communication, comprising:
a transmission unit adapted to transmit data;
a management unit adapted to manage transmission information including data identification information for identifying a type of data to be transmitted by said transmission unit, a destination address of the data to be transmitted, and a source address of the data to be transmitted;
a determining unit adapted to be operable when data to be transmitted by said transmission unit is of a specific type, to refer to the transmission information managed by said management unit, and out of the plurality of source addresses assigned to the communication apparatus, determine a source address that was used in the past for transmitting data to a destination address of the data to be transmitted, as a source address of the data; and
a control unit adapted to control said transmission unit such that said transmission unit transmits the data using the source address determined by said determining unit.

2. The communication apparatus according to claim 1, wherein after said transmission unit transmits data, said management unit acquires transmission information including data identification information, a destination address, and a source address from the transmitted data, and manages the acquired transmission information.

3. The communication apparatus according to claim 1, wherein the data of the specific type is data required to be transmitted using a same source address,
the communication apparatus further comprising:
a storage unit adapted to store the data identification information and attribute information of the data, in association with each other; and
an attribute-determining unit adapted to refer to information stored in said storage unit, including the data identification information and the attribute information, and determine whether or not the data to be transmitted by said transmission unit contains the attribute information, and
wherein if it is determined by said attribute-determining unit that the data to be transmitted does not contain the attribute information, said determining unit determines a predetermined source address as the source address of the data.

4. The communication apparatus according to claim 3, wherein if it is determined by said attribute-determining unit that the data to be transmitted contains the attribute information, said determining unit determines the same source address from the transmission information managed by said management unit, based on the data identification information associated with the attribute information and the destination address of the data to be transmitted.

5. The communication apparatus according to claim 1, further comprising a communication error-determining unit adapted to determine whether or not a communication error has occurred concerning data transmitted by said transmission unit, and
wherein if it is determined by said communication error-determining unit that a communication error has occurred, said management unit deletes the transmission information of the data from the transmission information managed by said management unit.

6. The communication apparatus according to claim 1, wherein when a predetermined time period elapses after transmitting data, or when a number of unsuccessful transmission attempts exceeds a predetermined number, or when deletion of the transmission information of the data is requested, said management unit deletes the transmission information of the data from the transmission information managed by said management unit.

7. A method of controlling a communication apparatus that is assigned a plurality of source addresses for use in network communication, comprising:
transmitting data;
managing transmission information including data identification information for identifying a type of data to be transmitted, a destination address of the data to be transmitted, and a source address of the data to be transmitted;
referring to, when data to be transmitted by said transmitting is of a specific type, the managed transmission information, and out of the plurality of source addresses assigned to the communication apparatus, determining a source address that was used in the past for transmitting data to a destination address of the data to be transmitted, as a source address of the data; and
controlling said transmitting such that said transmitting transmits the data using the determined source address.

8. A non-transitory computer-readable storage medium storing a computer-executable program for causing a communication apparatus that is assigned a plurality of source addresses for use in network communication,
wherein the method comprises:
transmitting data;
managing transmission information including data identification information for identifying a type of data to be transmitted, a destination address of the data to be transmitted, and a source address of the data to be transmitted;
referring to, when data to be transmitted by said transmitting is of a specific type, the managed transmission information, and out of the plurality of source addresses assigned to the communication apparatus, determining a source address that was used in the past for transmitting data to a destination address of the data to be transmitted, as a source address of the data; and
controlling said transmitting such that said transmitting transmits the data using the determined source address.
